(19) United States
(12) Patent Application Publication
(10) Pub. No.: US 2007/0046553 A1
(43) Pub. Date: Mar. 1, 2007

(54) Fine tuning mechanism of a satellite antenna

(75) Inventors: Hung-Yuan Lin, Taipei (TW); San-Yi Kuo, Taipei (TW); Wen-Jih Yeh, Taipei (TW)

Correspondence Address: LOWE HAUPTMAN BERNER, LLP, 1700 DIAGONAL ROAD, SUITE 300, ALEXANDRIA, VA, 22314, US

(73) Assignee: WISTRON NEWEB CORP., Taipei (TW)

(21) Appl. No.: 11/296,296

(22) Filed: Dec. 8, 2005

(30) Foreign Application Priority Data
Aug. 31, 2005 (TW) 94215034

(51) Int. Cl. H01Q 3/00

(52) U.S. Cl. 343/757

(57) ABSTRACT

A fine tuning mechanism of the satellite antenna is disclosed herein. This mechanism disposed in the elevation and azimuth fine tuning device includes a plurality of fine tuning elements, which include a plurality of rollers, a bushing and a bearing. By this mechanism, it is easy to tune to the needed angle with high accuracy. The user can use the handle to easily tune the right elevation and azimuth.

### BACKGROUND OF THE INVENTION

1. Field of the Invention

The present invention generally relates to a fine tuning mechanism of the satellite antenna, and more particularly to an elevation and azimuth fine tuning mechanism of the satellite antenna.

2. Description of the Prior Art

Parabolic satellite antenna is a high-directional receiving antenna. The center of the parabolic antenna should be accurately aligned to the satellite in the aerospace. At present, the signal frequency of the satellite is rising from KU to KA. This leads to a higher sensitivity on the directionality of the satellite signals. (Also means narrower Antenna Radiation Lobes Beamwidth). The traditional satellite antennas are without the fine tuning mechanisms. The fine tuning for the azimuth is all done by hand. This suffers the disadvantages of time-wasting and hard to accurately receive the single from the satellite. By using this method to fine tuning the antenna, the step, lock-down, is usually generating a displacement from the position of the original angle.

### SUMMARY OF THE INVENTION

In view of the foregoing, it is an object of the present invention to improve the fine tuning mechanism of the satellite antenna such that it is able to work without the lock-down step after fine tuning and avoids generating the displacement. This also makes the fine tuning procedure smoothly, decreasing the tuning forces, and increasing the sensitivity of azimuth fine tuning.

A further object of the present invention is to provide a fine tuning mechanism of the satellite antenna, in which the fine tuning angle is able to highly accurate alignment, and easily to align to the precise positions for the elevation and azimuth.

According to one embodiment of the present invention, in order to increase the sensitivity of the azimuth and reduce the gaps during fine tuning procedure, a screw bolt was fastened into a bearing between the azimuth bracket and mount base of this mechanism. This makes the fine tuning of the azimuth smoother. By using this mechanism, the screw force during fine tuning procedure is lowered by eliminate the gaps among rotation center. In order to recognize the properties and the functions, the details are described as the following sections.

### BRIEF DESCRIPTION OF THE DRAWINGS

FIG. 1 schematically illustrates a perspective view, revealing the layout of the fine tuning mechanism of the satellite antenna according to one embodiment of the present invention.

FIG. 2 schematically illustrates a top cross-sectional view of the roller arrangement of the fine tuning mechanism of the satellite antenna according to one embodiment of the present invention.

FIG. 3 schematically illustrates the side cross-sectional view, showing the position relationship of the mount base and azimuth bracket of the fine tuning mechanism according to one embodiment of the present invention.

FIG. 4 schematically illustrates the position relationship of the parts of the fine tuning mechanism, according to one embodiment of the present invention.

### DETAILED DESCRIPTION OF THE INVENTION

This invention is a fine tuning mechanism of the satellite antenna. Based on the prior conventional mechanism, this invention introduces the new parts, that comprising rollers, bearings and bushings. The objectives of the rollers are to increase the sensitivity, decrease the wear and tear of the mechanism during the fine tuning procedure. The objectives of the bearings and bushings are in order to smooth the rotation and to avoid to get stuck by the abrasion among the materials of the parts. By combination of these parts into this mechanism, the stability is able to enhance during the fine tuning procedure.

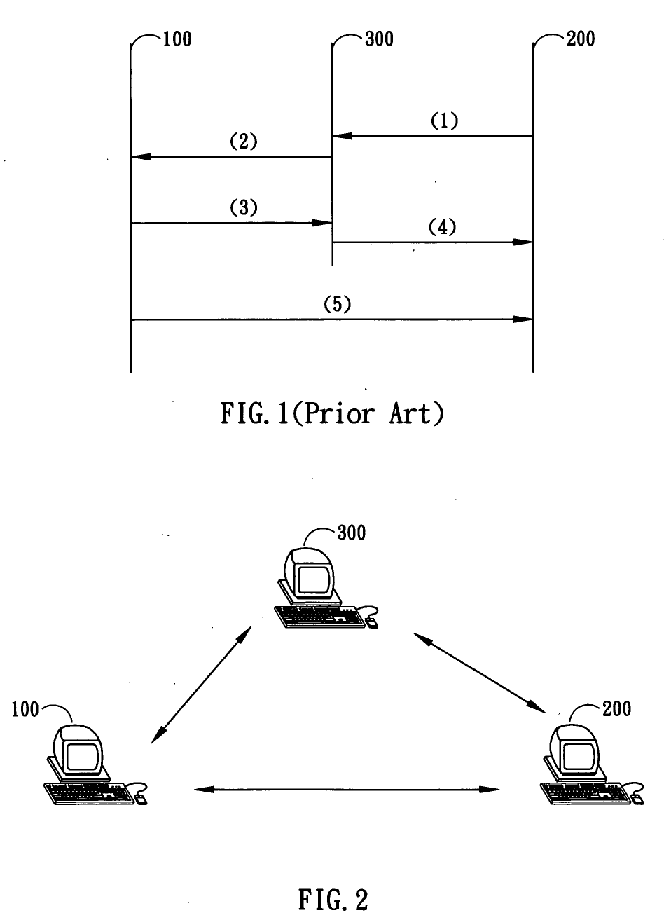

FIG. 1 schematically illustrates the perspective view of the fine tuning apparatus 10 of the satellite antenna, in which the basic structure of the fine tuning apparatus includes an elevation fine tuning bolt 110, an elevation fine tuning shaft 120, an elevation bracket 130, an azimuth fine tuning shaft 140, an azimuth bracket 150, a hollow column 160, a mount base 170, a handle 180 etc. The function of the apparatus 10 is on fine tuning the elevation and azimuth of the satellite antenna. The objectives of this invention is disposed a fine tuning mechanism between the azimuth bracket 150 and mount base 170, by which, the sensitivity will be increased, the friction will be decreased, and the case of parts-locked by the abrasion of materials will be avoided.

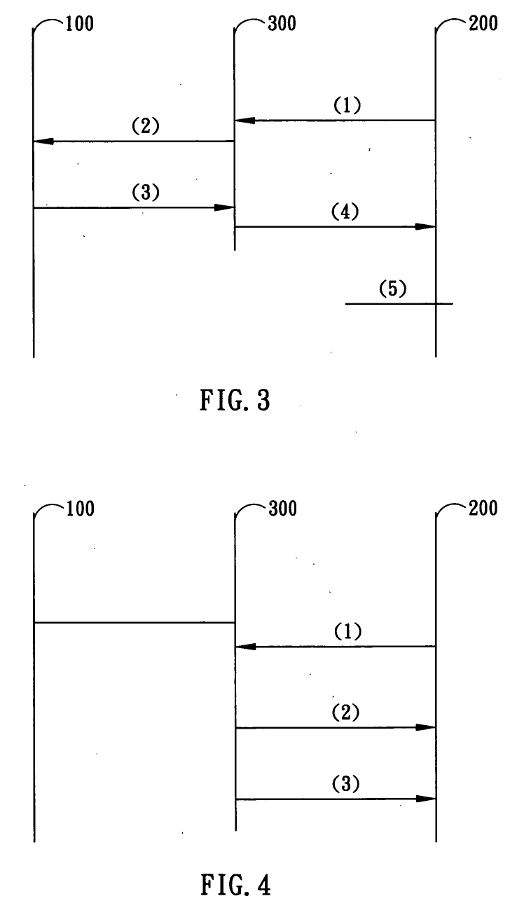

FIG. 2 is the top cross-section view of the fine tuning mechanism 20, showing the arrangement of the rollers 220. These rollers are fixed on the mount base 210 and arranged in a circular formation between the mount base 210 and the azimuth bracket 150. The azimuth bracket 150, which is fixed by the screws on the corners, and the mount base 210 are inter-rotating with each other during the fine tuning procedure. By the surface contact and the induced action between the rollers 220 and the azimuth bracket, this design is not only decreasing the unnecessary friction, but also efficiently increasing the sensitivity of the fine tuning mechanism, and help to lower the rotating forces during the fine tuning procedure. The number of the roller 220 in the embodiments is either two, four, six, or eight and so on, as long as the mechanism is able to maintain in balance and increasing the sensitivity.

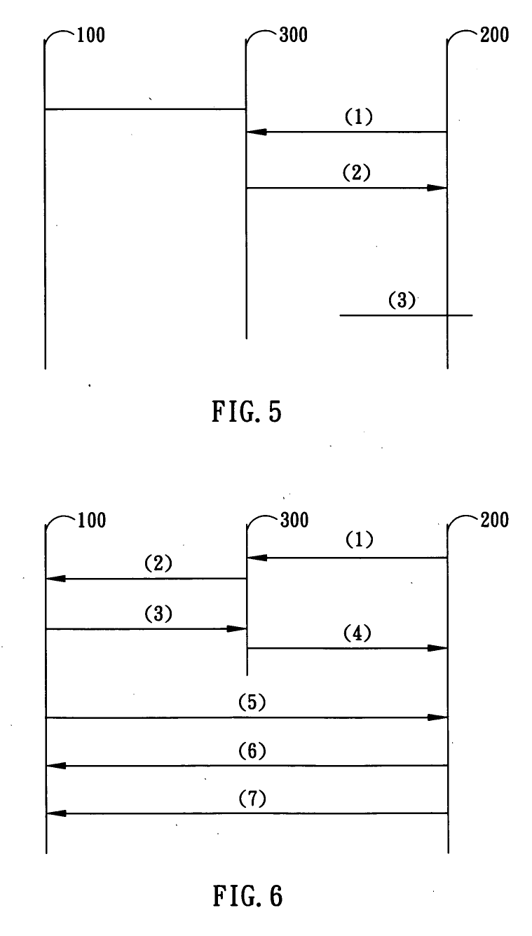

FIG. 3 schematically illustrates the side cross-section view of the part of the assembly 30 that fixed on the mount base 310. The mount base 310 has a room where the rollers 320 are disposed and the azimuth bracket 330 is then dispose on top of the rollers 320, using top washer 340 and the bottom washer 350 clipping these parts, and the screws 360 fixing the parts together. When the azimuth bracket 330 is under a normal applying force, it is higher compared with the mount bracket 320 by the design and an interval, A, between these two parts is about 0.02-0.05 mm in length. When the azimuth bracket 330 and the mount base 310 are fixing by the screw and under an applying force, because of the interval A, the washer will not generate a huge friction by tightly locked, and the sensitivity of the azimuth fine tuning will not be affected.

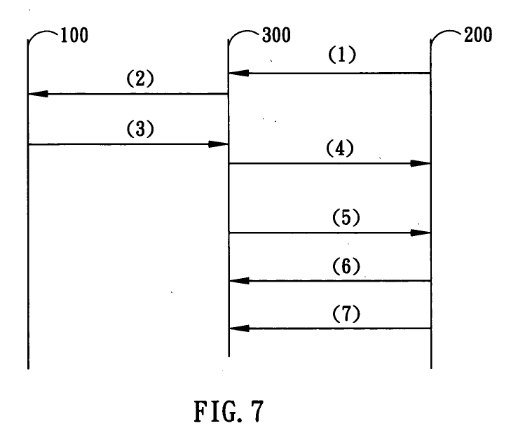

FIG. 4 schematically illustrates the perspective view of the fine tuning mechanism 40, comprising a mount base 410, a plurality of the rollers 420, a pillar 430, a bushing 440, an azimuth bracket 450, a thrust bearing 460, a nut 470, and a bolt 480. A plurality of the rollers 420 are disposed on the mount base 410 and arranged in a circular formation. The pillar is disposed in the center of the mount base. The bushing 440 is put between the mount base 410 and the azimuth bracket 450. The thrust bearing 460 is on the azimuth bracket 450 and just below the nut 470 and the bolt 480.

According to the FIG. 4, in order to increase the sensitivity of the fine tuning mechanism, between the mount base 410 and the azimuth bracket 450, the bushing 440, which is tightly fixing on the mount base 410, and the thrust bearing 460, which is connected with the azimuth bracket 450, are combined with the designed rollers 420 to increase the stability of the fine tuning of the azimuth.

In this invention, the introduced rollers are to improve the sensitivity during the fine tuning procedure. Besides the detailed description of the previous embodiment, it is appreciated that the quantity of the rollers may be greater or less than that disclosed, or the arrangement of the rollers may be changed but complies with the principle of symmetry to achieve the expectant objectives of the invention. The function of the thrust bearing is to smooth the action of the mechanism. If the bearing is omitted, the function of the rollers is still working by slightly increasing the applying forces, as well as the function of the fine tuning mechanism. Otherwise, the quantity of the bushings may be greater or less than that disclosed, by partially modified to achieve the objectives.

As the invention may be embodied in several forms without departing from the spirit of essential characteristics therefore illustrative and not restrictive, and all changes that fall within meets and bounds of the claims, or equivalence of such meets and bounds are therefore intended to be embraced by the claims.

What is claimed is:

1. A fine tuning mechanism of a satellite antenna, comprising:
a mount base;
a pillar, disposed at the center of the mount base;
an azimuth bracket, assembled on the mount base;
a set of a screw, a nut, and a bolt, to lock said azimuth bracket and said mount base; and
a fine tuning module, comprising a plurality of rollers, disposed on said mount base and contacted with said azimuth bracket, thereby said azimuth bracket could be moved on said mount base.

2. The fine tuning mechanism of the satellite antenna according to claim 1, further comprising a thrust bearing which is on said azimuth bracket.

3. The fine tuning mechanism of the satellite antenna according to claim 1, wherein said rollers are arranged in a circular formation.

4. The fine tuning mechanism of the satellite antenna according to claim 1, wherein said azimuth bracket is higher than said mount base with the interval between 0.02-0.05 mm after assembling both of them.

5. The fine tuning mechanism of the satellite antenna according to claim 1, further comprising:
a bushing disposed between said mount base and said azimuth bracket, and
a thrust bearing disposed between said bolt and said azimuth bracket.

6. The fine tuning mechanism of the satellite antenna according to claim 5, wherein combination of said bushing and said mount base, which connected with said azimuth bracket by said thrust bearing, increases the stability with said rollers during fine tuning procedure.

7. A satellite antenna, comprising:
an adjustable module, comprising a plurality of rollers and a pillar on said module;
a set of screws and nuts, and a bolt, which are attached and disposed on said pillar;
a fixing module, which is disposed with said adjustable module by said screw set and said bolt, wherein a surface of said fixing module is attached with said adjustable module and could be moved on it.

8. A satellite antenna according to claim 7, further comprising a thrust bearing, which is disposed between said screw set and said fixing module.

9. A satellite antenna according to claim 7, wherein said rollers are arranged in a circular formation.

10. A satellite antenna according to claim 7, wherein said fixing module is higher than the adjustable module after combined with each other and the interval therebetween is about 0.02-0.05 mm.

11. A satellite antenna according claim 7, further comprising:
a bushing disposed between said adjustable module and said fixing module, and
a thrust bearing disposed between said bolt and said fixing module.

12. A satellite antenna according claim 11, wherein combination of said bushing and said mount base connected with said azimuth bracket by said thrust bearing, increases the stability during fine tuning procedure with said rollers.

13. A satellite antenna according claim 7, further comprising a bushing, which encompasses the pillar.
